(19) United States
(12) Patent Application Publication
(10) Pub. No.: US 2013/0258667 A1
(43) Pub. Date: Oct. 3, 2013

(54) MOUNT FOR REPLACEABLE OPTICS IN LED LIGHTING MODULE

(71) Applicants: Steven Howard Ray, Longmont, CO (US); Brett James Pardikes, Arvada, CO (US)

(72) Inventors: Steven Howard Ray, Longmont, CO (US); Brett James Pardikes, Arvada, CO (US)

(21) Appl. No.: 13/804,446

(22) Filed: Mar. 14, 2013

Related U.S. Application Data
(60) Provisional application No. 61/617,324, filed on Mar. 29, 2012.

(51) Int. Cl. F21V 21/00

(52) U.S. Cl. CPC F21V 21/00
USPC 362/249.02

(57) ABSTRACT

Systems and methods for mounting optics to an LED lighting module include a retainer engageable with the lighting module and a removable upper plate for securing the optics in the retainer.

### CROSS-REFERENCE TO RELATED APPLICATION

This application claims priority to, and the benefit of, U.S. Provisional Application Ser. No. 61/617,324, filed on Mar. 29, 2012, the entire disclosure of which is hereby incorporated by reference.

### FIELD OF THE INVENTION

The technology disclosed herein relates, in general, to light emitting diodes (LEDs) and, more specifically, to systems and methods for mounting replaceable optics in an LED lighting module.

### BACKGROUND

LED lighting sources are an increasingly popular choice over traditional incandescent bulbs due to their lower energy consumption, smaller size, and longer operational lifetime. In contrast to lighting sources that emit light in all directions, which intrinsically increases energy losses, LEDs emit light beams with high directionality (e.g., beam angle between 90° and 120°). LEDs, therefore, ideally radiate light in the desired direction with almost no reflective loss. In practice, however, the LED beam angle may nonetheless be too wide for use in a lighting fixture. Secondary optics, such as a total internal reflection (TIR) optic, are utilized to collimate lambertian light from an LED to a more focused beam angle (e.g., ±6°).

Conventionally, a retention mount is used to position a secondary optical element at the correct location relative to the LEDs. Typical retention mounts, however, receive only a single optic; as a result, multiple mounts are employed when more than one secondary optic is required for a particular illumination application. Once affixed to a mount, the optics are generally sealed within the LED lighting module to keep the optics in place; this makes replacement of a damaged optic difficult or impossible.

Consequently, there is a need for an optic mount that can removably receive multiple optics in an LED lighting module, and which does not require sealing to maintain configurational stability.

### SUMMARY

In various embodiments, the present invention relates to systems and methods for removably mounting multiple optics in a retainer that is firmly attached to the LED lighting module. The retainer correctly positions the secondary optics at desired locations relative to the LEDs. If the optics need to be removed or replaced, an upper plate that firmly holds the optics in place in the retainer may be easily detached therefrom, thereby leaving other components (e.g., the LED circuitry) in the LED lighting module undisturbed. Additionally, because each retainer may include multiple retention regions, multiple retained optics may coexist within a single LED lighting module while maintaining a desired overall beam pattern. As used herein, the term “LED lighting module” refers to a system or assembly that includes the actual LED(s) and support and/or driver circuitry.

Accordingly, in one aspect, the invention pertains to a system for mounting optics to an LED lighting module including one or more LEDs connected thereto and circuitry for the one or more LEDs. In various embodiments, the system includes a retainer engageable with the lighting module and including one or more retention region configured to retain one or more optical element in a fixed configuration with respect to the one or more LEDs; and a removable upper plate for securing the one or more optical element in the retainer without contacting the circuitry.

In various embodiments, the retainer is engageable to a heat sink of the LED lighting module and the heat sink is disposed below the one or more LEDs. In addition, the system may include a thermally conductive material applied in a gap between the retainer and the heat sink for efficiently dissipating waste heat. In one implementation, the retainer includes multiple retention collars, each retainably accommodating a geometry of an individual optical element. The retention collar may include a retention element protruding therefrom for retaining the optical element. In addition, an inner surface of the retention collar may frictionally engage the optical element.

The system may further include means for facilitating removable clamping of the upper plate to the retainer. In one embodiment, the system includes an adjustment element for adjusting a position of the optical element in the fixed configuration.

In another aspect, the invention relates to a method of mounting one or more optical element to an LED lighting module including multiple LEDs. In various embodiments, the method includes positioning the one or more optical element in a retainer at a desired position relative to one or more LEDs; and removably securing the retainer to the lighting module such that the optical element is fixedly retained at the desired position without contact with any circuitry. In one implementation, the method further includes adjusting the optical elements in the retainer using an adjustment element.

The optical element may be secured to the retainer by an upper plate engageable with the retainer. In addition, the optical element may be retained in the retainer by an element protruding therefrom. In various embodiments, an inner surface of the retention collar frictionally engages the optical element. In one implementation, the retainer is removably secured by an upper plate.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 is an exploded view of an LED lighting system in accordance with an embodiment of the present invention;

FIG. 2A is an exploded view of a mounting system in accordance with an embodiment of the invention; and

FIG. 2B is an exploded view depicting retention collars of a mounting system incorporating features for gripping the optical elements in accordance with an embodiment of the invention.

### DETAILED DESCRIPTION

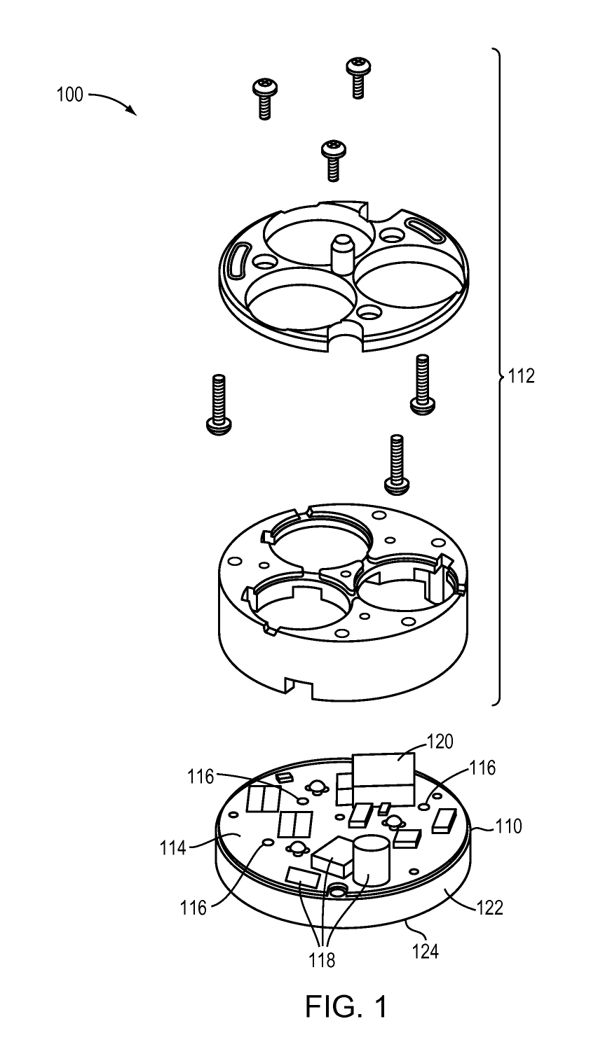

FIG. 1 illustrates an LED lighting system 100 that includes an LED lighting module 110 and a mounting system 112. The LED lighting module 110 may include a circuit board 114 on which at least some of the LED lighting module components, including the LED(s) 116, LED supporting circuitry 118 and/or LED driver circuitry 120, are assembled. Circuitry 118, 120 is conventional; for example, the supporting circuitry 118 may include one or more of a current-regulation circuit, a temperature-sensing circuit, a light-sensing circuit and/or a dimming circuit and the driver circuitry 120 provides power to the LED(s) 116 (e.g., converting power from the AC mains to a suitable DC operating voltage). In some embodiments, the circuit board 114 may be a printed circuit board (PCB), a metal plate or other conductive or non-conductive material with circuit traces electronically connecting the LED(s) 116, supporting circuitry 118, and/or driver circuitry 120. For example, the circuit board 114 may be made of a lightweight material having a high thermal conductivity (e.g., aluminum). At least a part of the circuit board 114 is anodized to provide electrical isolation between various electronic components. In one embodiment, the electrical isolation is created using, for example, a thin-film deposition process.

In some embodiments, the LED lighting module 110 includes a heat sink 122 (typically made of metal or another highly thermally conductive material) for dissipating the heat generated by the supporting circuitry 118, driver circuitry 120 and/or LED(s) 116. The circuit board 114 and/or the heat sink 122 may include a flat or curved bottom surface 124 that is capable of attaching or conforming to a variety of surfaces in various lighting applications. In addition, the bottom surface 124 may be made of a substantially rigid or slightly flexible material, such as plastic, metal, and/or another suitable material to accommodate deformation in the course of installation or use.

In one embodiment, the LED lighting module 110 includes various combinations of red-, green-, and/or blue-emitting LED(s) 106 and emits various colors of light or substantially white light derived from the mixture of the red, green, and blue light. LED(s) 106 may also include amber-emitting LED(s). In addition, the output characteristics (such as light uniformity, dimming, brightness, or color) of the LED lighting module 110 may be regulated by varying the current passing through the LED(s) 106 and/or by altering the duration of operation of the LED(s) 106 using the LED driver circuitry 120 and/or the supporting circuitry 118. For example, the color of light emitted by the LED lighting module 110 may be established by adjusting the output emission levels of differently colored LED(s) 106 so that the color-mixed output corresponds to a desired color. This may be implemented by changing the current level through each of the differently colored LED(s) 106 or the duration of operation of the LED(s) 106.

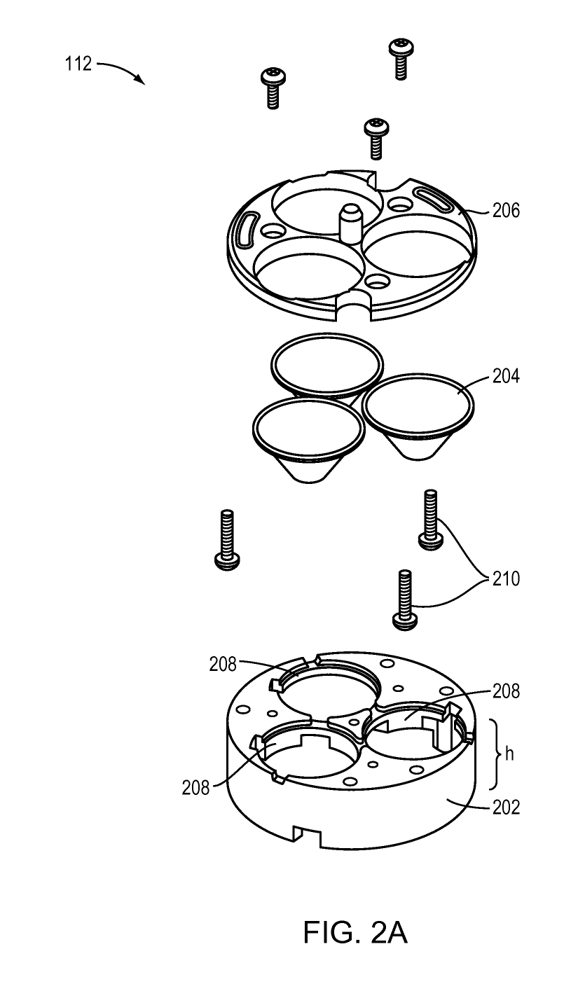

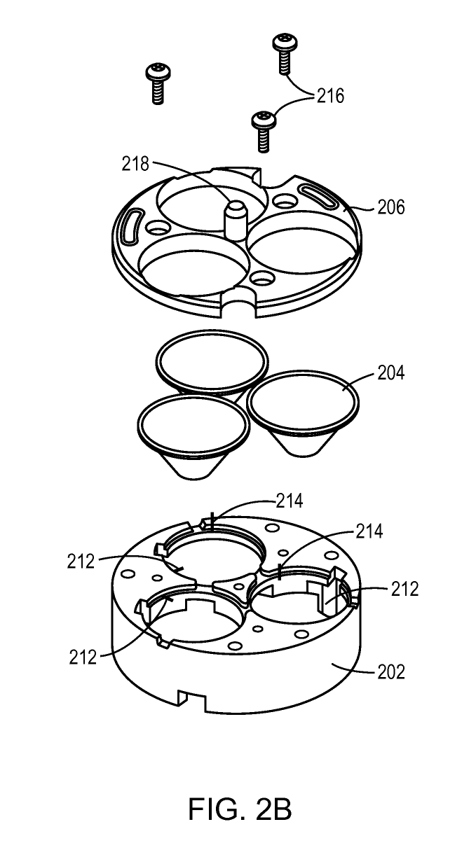

Referring to FIG. 2A, in various embodiments, the mounting system 112 includes a retainer 202 to accommodate one or more optical elements (such as lenses or reflectors) 204 and an upper plate 206 to ensure that the optical elements 204 are positioned correctly in the retainer 202. The retainer 202 may include multiple retention collars 208 each configured to hold an optical element 204. For presentation purposes, only three optical elements 204 are depicted in FIG. 2A; in practice, any number of optical elements 204 may be accommodated by the mounting system 112. The geometry of the retention collars 208 in the retainer 202 may be shaped and/or sized to accommodate various types of optical elements 204 such that the optical elements 204 can “nest” therein.

Thus, the retention collars 208 may be the same or different from each other depending on the mounted optical elements 204 and/or the desired beam pattern. For example, if the optical elements 204 have identical circumferences, the retention collars 208 may be identical in size and shape such that any of the optical elements 204 can be placed in any of the retention collars 208 of the retainer 202. If the optical elements 204 vary in geometry, however, the retention collars 208 in the retainer 202 may be customized such that each optical element 204 may be received in a complementary retention collar 208. In a preferred embodiment, each retention collar 208 supports a single optic element 204. However, a single retention collar 208 may hold multiple optical elements 204 as well; for example, optical elements 204 may be shaped and placed in contact with one another such that there is no space therebetween and the multiple optical elements 204 may then be fitted within the single retention collar 208. Additionally, the height h of the retainer 202 may be varied to accommodate differently sized optical elements 204 and facilitate proper placement relative to the LED lighting module 110 (e.g., directly above one or more LEDs at a desired distance therefrom). The retainer 202 may be firmly mounted to the lighting module 110 by a securing element, for example, one or more screws 210; this prevents any lateral movement between the retainer 202 and the lighting module 110. In some embodiments, the securing element may be a machine fastener (e.g. a clip) or magnetic fastener. In one embodiment, the retainer 202 is mounted to the heat sink 122 of the LED lighting module 110. In addition, materials having high thermal conductivity may be filled into a gap between the retainer 202 and the heat sink 122 to increase the efficiency of dissipating waste heat. Because the retainer 202 directly or indirectly contacts the heat sink 122 only, the LED(s) 116 and the circuitry 118, 120 remain undisturbed during assembly and disassembly of the mounting system 112 and the LED lighting module 110. In some embodiments, the retainer 202 is made of inexpensive materials, such as plastic.

Once the retainer 202 is securely attached to the LED lighting module 110, the optical elements 204 may be placed in the retention collars 208. The optical elements 204 are tightly secured in positions inside the retainer 202 to prevent movement or rattle. In various embodiments, the retention collars 208 grip the optical elements 204 predominantly via the friction between the optical elements 204 and the inner surfaces of the retention collars 208. In one embodiment, the inner surfaces of the retention collars 208 are roughened or textured, or provided with an inner-diameter coating or ring of, for example, rubber, in order to increase the static friction.

In various embodiments, the retention collars 208 incorporate another mechanism (preferably adjustable) for gripping the optical elements 204. Referring to FIG. 2B, the retention collars 208 may incorporate, for example, a ball, a rod, a compression spring, flexure bearing or other protruding feature 212 that exerts force against the optical elements 204; the features 212 are preferably rounded and/or cushioned or coated with elastic material to avoid damage to the optical elements 204. In some embodiments, the positions and orientations of the optical elements 204 in the retention collars 208 may be finely adjusted using adjustment components 214 (such as fine screws or removable knobs), ensuring that light emerges from the optical elements 204 with the proper beam angle and/or width. In some embodiments, the fine adjustments may place the optical elements 204 in axial alignment (i.e., making them substantially co-axial) with the optical center line of the LED(s) 106 or the LED lighting module 110, and/or may position the optical elements 204 at a required elevation above the LED lighting module 110. When the optical elements 204 reach the correct positions relative to the LED lighting module 110, the upper plate 206 may be attached to the retainer 202 by a securing element, for example, one or more screws 216. Pressure is desirably applied uniformly against the optical elements 204 when the upper plate 206 is secured to the retainer 202. The shape and size of the upper plate 206 and/or the top surface of the optical elements 204 may be customized to make the LED lighting system 100 compatible with various lighting applications. In one embodiment, the upper plate 206 includes an element (such as one or more posts 218) for facilitating manipulation and/or installation thereof. In another embodiment, if a flat upper surface of the mounting system 102 is desired, the post(s) 218 is removed.

During LED operation, if the optical elements 204 are to be removed or replaced, the upper plate 206 may be, for example, simply unscrewed and detached from the retainer 202. The optical elements 204 may then be removed or replaced with new optical elements without disturbing the LED(s) 106, circuitry 118, 120 or the circuit board 114 of the lighting module 110. After the new optical elements 204 are correctly positioned, the upper plate 216 may be clamped to the retainer 202 again, as described above. Embodiments of the current invention thus provide for convenient access to and adjustment or replacement of optical elements 204 in an LED lighting system without disturbing the LED(s), circuitry or other operative components.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A system for mounting optics to an LED lighting module comprising one or more LEDs connected thereto and circuitry for the one or more LEDs, the system comprising:
a retainer engageable with the lighting module and comprising at least one retention region configured to retain at least one optical element in a fixed configuration with respect to the at least one LEDs; and
a removable upper plate for securing the at least one optical element in the retainer without contacting the circuitry.

2. The system of claim 1, wherein the retainer is engageable to a heat sink of the LED lighting module, the heat sink being disposed below the one or more LEDs.

3. The system of claim 2, further comprising a thermally conductive material applied in a gap between the retainer and the heat sink for efficiently dissipating waste heat.

4. The system of claim 1, wherein the retainer comprises a plurality of retention collars each retainably accommodating a geometry of an individual optical element.

5. The system of claim 4, wherein the retention collar comprises a retention element protruding therefrom for retaining the optical element.

6. The system of claim 4, wherein an inner surface of the retention collar frictionally engages the optical element.

7. The system of claim 1, further comprising means for facilitating removable clamping of the upper plate to the retainer.

8. The system of claim 1, further comprising an adjustment element for adjusting a position of the optical element in the fixed configuration.

9. A method of mounting at least one optical element to an LED lighting module comprising a plurality of LEDs, the method comprising:
positioning the at least one optical element in a retainer at a desired position relative to at least one of the plurality of LEDs; and
removably securing the retainer to the lighting module such that the optical element is fixedly retained at the desired position without contact with any circuitry.

10. The method of claim 9, wherein the optical element is secured to the retainer by an upper plate engageable with the retainer.

11. The method of claim 9, wherein the optical element is retained in the retainer by an element protruding therefrom.

12. The method of claim 9, wherein an inner surface of the retention collar frictionally engages the optical element.

13. The method of claim 9, further comprising adjusting the optical elements in the retainer using an adjustment element.

14. The method of claim 9, wherein the retainer is removably secured by an upper plate.
